(19) United States
(12) Patent Application Publication
(10) Pub. No.: US 2007/0155856 A1
(43) Pub. Date: Jul. 5, 2007

(54) POLYMER RESIN BINDER, PIGMENT DISPERSIONS, AND INK-JET INK FOR COLOR FILTER

(75) Inventors: In-seo KEE, Gyeonggi-do (KR); Chun YOON, Seoul (KR); Yoon-doe JONG, Seoul (KR); Jung-yong LEE, Seoul (KR); Seong-jin KIM, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Gyeonggi-do (KR)

(21) Appl. No.: 11/548,523

(22) Filed: Oct. 11, 2006

(30) Foreign Application Priority Data
Dec. 30, 2005 (KR) 10-2005-0135847

(51) Int. Cl. C09D 11/00

(52) U.S. Cl. 523/160; 523/161

(57) ABSTRACT

Provided is a polymer resin binder included in an inkjet ink for a color filter which is manufactured by polymerizing multiple types of functional monomer including: a monomer having an affinity for the pigment; a monomer having high mechanical strength; or a monomer having an affinity for a solvent, and contains an amine based organic material. Accordingly, the polymer resin, binder for forming inkjet ink for a color filter can improve a dispersion property and dispersion stability and an ejection property and ejection stability of inkjet ink.

### CROSS-REFERENCE TO RELATED PATENT APPLICATION

This application claims priority to Korean Patent Application No. 10-2005-0135847, filed on Dec. 30, 2005, and all the benefits accruing therefrom under 35 U.S.C. § 119(a), the contents of which is herein incorporated by reference in its entirety.

### BACKGROUND OF THE INVENTION

1. Field of the Invention

The present invention relates to a polymer resin binder included in an inkjet ink for a color filter, and more particularly, to a polymer resin binder included in an inkjet ink for a color filter which can improve a dispersion property and dispersion stability of the inkjet ink, and an ejection property and ejection stability of the inkjet ink.

2. Description of the Related Art

Inkjet ink is a useful component for the manufacture of a color filter, which is one of the main components of a liquid crystal display device. Inkjet ink is used to form the color filter provides image realization in a liquid crystal display device. In the color filter, three colors of inkjet ink of red, blue, and green, are coated onto a color filter substrate by being sprayed using an inkjet head, coated, and then thermally hardened. Accordingly, the inkjet ink forms an ink film, which is a colored layer, in the color filter.

The basic structure and operation of a color filter will be described briefly as follows.

Light generated from a backlight unit is selectively allowed to pass through a polarization plate and liquid crystals sequentially, and the passing light finally passes through a color filter, thereby forming a color image by combining images of three colors. Accordingly, the final quality of an image seen by human eyes is decided by the quality of the color filter, and the quality of the color filter is decided by the quality and kind of pigment and additives used in the inkjet ink.

A colored layer can be formed in a color filter using inkjet ink as described above or using photosensitive resins.

The method using an inkjet ink to form a colored layer has the following advantages over the method using a photosensitive resin. That is, processes like coating, exposing, and developing for each color are not required, but instead three colors of red, green, and blue can be coated at the same time and then hardened, thereby reducing the number of processes and minimizing waste of the material and waste of solution. Accordingly, research is also being conducted for replacing the photosensitive resin used to form the colored layer of a color filter with inkjet ink.

Inkjet ink for a color filter includes a pigment dispersion, a polymer resin binder, a functional monomer, a heat initiator, and a surfactant. Other additives, and a solvent may also be included.

The pigment dispersion, a core element of inkjet ink, is manufactured from three colors of red, green, and blue pigments which are dispersed as super corpuscles present in a colloidal state in a solvent. Accordingly, the super corpuscle in a colloid state must have good dispersion and the dispersion stability thereof should not change under any physically or chemically inappropriate conditions.

More specifically, the pigment dispersion is manufactured by mixing a solvent, a dispersion agent, and other additives to a pigment in an appropriate, predetermined ratio, and then pulverizing the mixture in a pulverizer. The inkjet ink is then manufactured by mixing a polymer resin binder, a multifunctional monomer, an initiator, and other additives with the pigment dispersion.

In the manufacture of a pigment dispersion as described above, the dispersion agent is a polymer type surfactant, and plays a key role in maintaining a stable disperse system. Also, recently, as technology in the field of liquid crystal display devices is developing at a high speed, liquid crystal display devices having high transmittance, high chromaticity, high brightness, and high contrast have been realized, and thus the pigment dispersion and the polymer resin binder need to be improved accordingly.

That is, in the case of a conventional high transmittance color filter, the concentration of the pigment does not have to be high and therefore a large amount of dispersion agent compared to pigment can be used. When the concentration of the dispersion agent is high, a good dispersion property and dispersion stability are thereby maintained. However, as liquid crystal display devices are being developed, more high chromaticity is required, and for high chromaticity realization, a large amount of pigment must be present in the optical path (i.e., must be “stacked”) of the color filter, and the usage of the disperse agent should be reduced in contrast. Thus, when a small amount of disperse agent is used, the dispersion property and the dispersion stability of the pigment particle in the form of a super corpuscle decreases.

The polymer resin binder is desirably used for manufacturing both the pigment dispersion and the inkjet ink, and can thus improve the dispersion property and dispersion stability of the pigment. Conventional commercialized polymer resin binders mixed with dispersion agents to manufacture pigment dispersions.

However, conventional commercialized polymer resin binders cannot provide sufficient dispersion properties and the dispersion stability of the pigment.

### BRIEF SUMMARY OF THE INVENTION

The present invention provides, in an embodiment, a polymer resin binder which can improve a dispersion property and dispersion stability of a pigment when used to manufacture an inkjet ink for a color filter of a liquid crystal display device.

The present invention also provides, in an embodiment, a polymer resin binder which is used to manufacture an inkjet ink for a color filter of a liquid crystal display device and which can improve ink ejection property and ejection stability when ejected from an inkjet head.

According to an embodiment of the present invention, there is provided a polymer resin binder of inkjet ink for a color filter which comprises a polymer comprising multiple types of functional monomer, wherein the polymer resin binder contains an amine based organic material represented by Formula 1 below:

[—NHₓR_{y}], Formula 1

where R is a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkyl aryl group, a C₇₋₄₀ arylalkyl group, a C₈₋₄₀ arylalkenyl group, a C₂₋₁₀ alkynyl group, or a combination comprising at least one of the foregoing groups; and x is 0 to 2, y is 1 to 3, and x+y=3.

According to an embodiment, the functional monomer may comprise: (a) styrene or benzyl methacrylate; and (b) methacrylic acid, acrylic acid, methacrylamide, or acrylamide.

According to another embodiment, the amine based organic material may be at least one selected from the group consisting of aniline, N-alkylaniline, 2-ethylhexylamine, triethylamine, pentyl amine, n-hexylamine, p-aminobenzoic acid, pyrrolidine, pyrimidine, morpholine, pyridine, piperazine, and quinoline.

The amine based organic material may be 0.1-30 weight % based on 100 weight % of the total of (a) and (b).

When the content of (a) may be 0.3 to 5, the content of (b) may be 0.3 to 5, based on the molar ratio.

The functional monomer may further comprise (c) methacrylate having a C₁₋₅ alkyl group or 2-hydroxy ethyl group.

The content of the amine based organic material may be 0.1 to 30 weight % based on 100 weight % of the total of (a) through (c).

When the content of (a) may be 0.3 to 3.0, the content of (b) may be 0.2 to 2.5, and the content of (c) may be 0.3 to 3.0, based on the molar ratio.

According to another embodiment of the present invention, there is provided a pigment dispersion included in an inkjet ink for a color filter which comprises a pigment, a dispersion agent, a surfactant and a polymer resin binder.

The surfactant may be a fluoric surfactant.

The pigment may be at least one selected from the group of pigments consisting of red 254, red 177, blue 15:6, green 36, yellow 150, yellow 139, yellow 138, and violet 23.

The content of the polymer resin binder may be 20-150 weight % based on 100 weight % of the total pigment.

The content of the dispersion agent may be 0.1-30 weight % based on 100 weight % of the total pigment, and the content of the surfactant may be 0.01-2 weight % based on 100 weight % of the total pigment.

According to another embodiment of the present invention, the amine based organic material may be in a physically bonded state.

According to another embodiment of the present invention, the amine based organic material may be in a chemically bonded state.

According to another embodiment of the present invention, there is provided an inkjet ink for a color filter manufactured using the pigment dispersion.

According to another embodiment of the present invention, there is provided a method of manufacturing a polymer resin binder of inkjet ink for a color filter comprising polymerizing multiple functional monomers and an amine based organic material.

According to another embodiment of the present invention, there is provided a method of manufacturing a pigment dispersion included in an inkjet ink for a color filter comprising mixing a pigment, a dispersion agent, a surfactant, and a polymer resin binder comprising an amine based organic material.

According to another embodiment of the method, the polymer resin binder is added to the pigment dispersion. In a further embodiment, the method of making the pigment dispersion comprises mixing at least two polymer resin binders to form a binder mixture, and further mixing a pigment, a dispersion agent, and surfactant with the binder mixture.

According to another embodiment of the present invention, there is provided method of making an inkjet ink, comprising mixing a pigment, a dispersion agent, a surfactant, and a polymer resin binder comprising an amine based organic material wherein during the manufacture of the inkjet ink the polymer resin binder is added to the pigment dispersion.

According to an embodiment of the present invention, during the manufacture of the inkjet ink for a color filter, the polymer resin binder may be added to the pigment dispersion.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a basic structure of an exemplary polymer resin binder according to an embodiment;

FIG. 2A is a photograph showing the degree of condensation of conventional inkjet ink not containing an amine based organic material for a color filter; and

FIG. 2B is a photograph showing the degree of condensation of an exemplary inkjet ink containing an amine based organic material for a color filter according to an embodiment.

### DETAILED DESCRIPTION OF THE INVENTION

The present invention will now be described more fully with reference to the accompanying drawings, in which exemplary embodiments of the invention are shown.

It will be understood that when an element is referred to as being “on” another element, it can be directly on the other element or intervening elements may be present therebetween. In contrast, when an element is referred to as being “disposed on” another element, the elements are understood to be in at least partial contact with each other, unless otherwise specified.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Thus, a polymer resin binder comprises a plurality of functional monomers and contains an amine based organic material represented by Formula 1 below. The polymer resin binder included in an inkjet ink for a color filter, wherein the polymer is manufactured by polymerizing a plurality of monomers, contains an amine based organic material represented by Formula 1 below:

[—NHₓR_{y}], Formula 1

where R is a C₁₋₂₀ alkyl group, a C₁₋₁₀ alkoxy group, a C₆₋₂₀ aryl group, a C₆₋₁₀ aryl oxy group, a C₂₋₂₀ alkenyl group, a C₇₋₄₀ alkyl aryl group, a C₇₋₄₀ aryl alkyl group, a C₈₋₄₀ aryl alkenyl group, a C₂₋₁₀ alkynyl group, or a combination comprising at least one of the foregoing groups; and x is 0 to 2, y is 1 to 3, and x+y=3.

The polymer resin binder can be added to the pigment when the pigment dispersion is manufactured, added to the pigment dispersion when the inkjet ink is manufactured, or added in both processes. Accordingly, the polymer resin binder affects the properties of the pigment dispersion and the inkjet ink which contains the polymer resin binder.

Generally, inkjet ink must have a good dispersion property and dispersion stability, a good ejection property and ejection stability, high transparency, good chemical resistance, good mechanical durability, and high chromaticity realization.

To satisfy the above properties of the inkjet ink, the properties of the polymer resin can be adjusted.

For this, a polymer having a functional monomer comprising not one type monomer but multiple types of monomer is used.

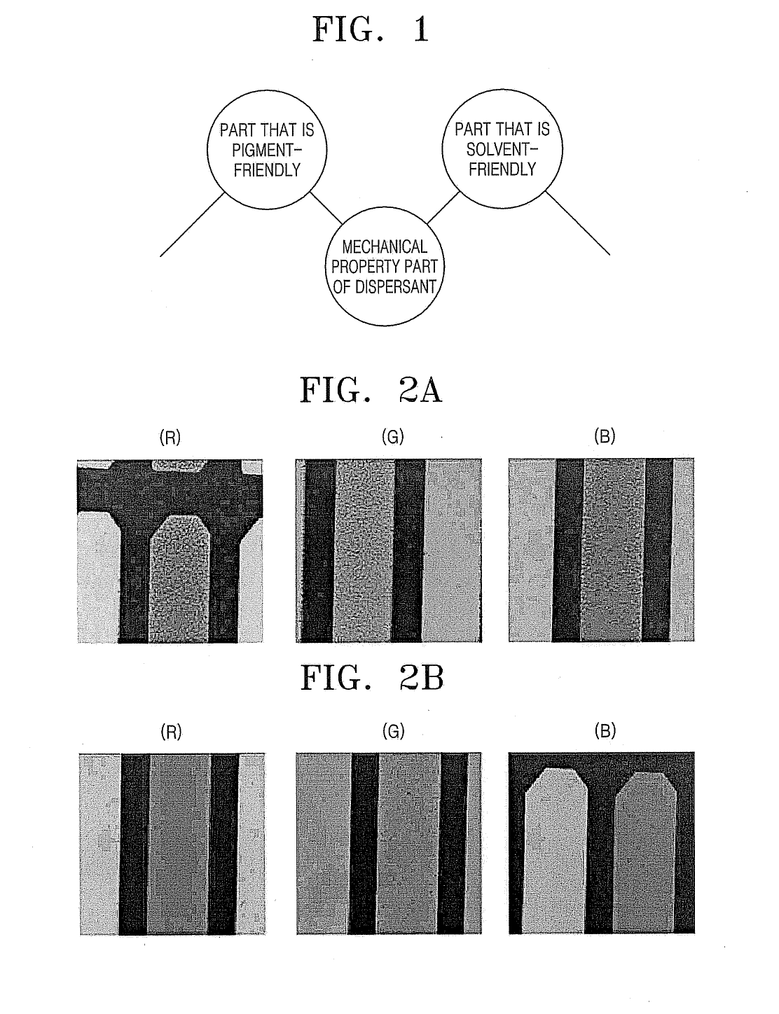

FIG. 1 is a diagram of a basic structure of monomers used in a polymer resin binder according to an embodiment.

The combination of monomers provides desired properties. Referring to FIG. 1, a monomer having an affinity for the pigment, a monomer having high mechanical strength, and a monomer having an affinity for the solvent are combined in combinations possessing two or three of the foregoing desired properties, to be used as the functional monomer. Thus, the synthesized polymer resin binder is useful with various kinds of pigments, thereby improving the low viscosity dispersion property and dispersion stability of the pigment dispersion and inkjet ink.

As an example of the functional monomer, two kinds of monomers can be combined to be used as a functional monomer, such as monomer (a) having an affinity for the pigment and monomer (b) having an affinity for the solvent. In an embodiment, when the molar content of monomer (a) is of 0.3 to 5, the molar content of monomer (b) is 0.3 to 5 based on the molar ratio (a) and (b).

As another example of the functional monomer, three types of monomer can be combined to be used as a functional monomer, such as monomer (a) having an affinity for the pigment, monomer (b) having an affinity for the solvent, and monomer (c) having good mechanical strength. In this case, the molar content of monomer (a) may be 0.3 to 3.0, the molar content of monomer (b) may be 0.2 to 2.5, and the molar content of monomer (c) may be 0.3 to 3.0, based on the molar ratio of (a), (b), and (c).

Monomer (a) has an affinity for a pigment. More particularly, monomer (a) has an affinity for a benzene or alkyl group of the pigment, and may be styrene, benzyl methacrylate, 2-ethylhexyl methacrylate, or 2-ethylhexylacrylate, and the like.

Monomer (b) having an affinity for a solvent may be methacrylic acid, acrylic acid, methacrylamide, acrylamide, and the like.

Also, monomer (c) having good mechanical strength may be methacrylate including a C₁₋₅ alkyl group or 2-hydroxy ethyl group, or butyl acrylate, and the like.

The monomers used in the present invention are not limited to these, and various commercially usable monomers such as methyl methacrylate, glycidyl methacrylate, and the like, can be used. Of these monomers, glycidyl methacrylate can provide a copolymer with higher hardness and improved chemical resistance due to epoxy cross-linkage during thermal hardening. Accordingly, in an exemplary embodiment, glycidyl methacrylate is useful for the manufacture of an inkjet ink for a color filter.

The relative molar ratio and kinds of functional monomers used may vary according to the desired properties of the copolymer. Specifically, the optimum useful molar ratios and kinds of the monomers must be decided in consideration of the degree of the polarity of the pigment, desired viscosity, and the characteristics of the solvent to be used.

A solvent is used in the synthesis of the polymer resin binder, of which protic and aprotic solvents except water can be used as the solvent. Examples of protic solvents include butyl alcohol, isopropyl alcohol, and ethyl alcohol. Examples of aprotic solvents include propylene glycol monomethyl ether acetate (“PGMEA”), dipropylene glycol methyl ether acetate, diethylene glycol monobutyl ether acetate, diglyme, and the like. However, aprotic solvents that have less reactivity than protic solvents are preferable for use for the manufacture of a polymer resin binder included in an inkjet ink for a color filter. Also, when a polymer resin binder is synthesized in the aprotic solvent, separation of the solvent from the polymer resin can be omitted, and is thus advantageous for reducing the number of manufacturing process operations.

The polymer resin binder contains an amine based organic material represented by Formula 1. Also, in an embodiment, the content of amine based organic material is 0.1-30 weight %, specifically 1-10 weight % based on 100 weight % of the total functional monomer.

The amine based organic material can be added when the polymer resin binder is synthesized or separately added after the polymer resin binder is polymerized. The amine based organic material can stabilize the particles of the dispersion by adjusting the degree of acidity and basicity of the organic acid or the amine based organic material that is included in the polymer resin binder or the pigment dispersion and can prevent ink aggregation when the inkjet ink is dried. Here, the amine based organic material can combine with the organic acid or the amine based organic material physically and/or chemically.

The mechanism of the dispersion stabilization of the pigment dispersion is as follows.

When water is used as a solvent, the pigment particles are dispersed by the anionic electrostatic repulsion of carboxyl groups (such as those introduced to the polymer resin binder by a carboxylic acid monomer, e.g., methacrylic acid) included in the polymer resin binder, which surrounds the pigment particles. In contrast, when an organic solvent is used, the pigment particles are dispersed by the steric hindrance effect of the polymer resin binder which surrounds the pigment particles. When an organic solvent is used, it is not necessary to introduce anions, but carboxyl acid group of methacrylic acid or acrylic acid, or amide group in methacrylamide or acrylamide in the structure of the pigment dispersion has an affinity for a protic or a polar aprotic organic solvent due to a hydrogen bond, thereby becoming stable. The pigments surrounded by the polymer resin binder or dispersion agent are blocked from interacting each other by the steric hindrance effect, thereby increasing the dispersion stability.

Basically, univalent, divalent, or trivalent amine can be used as the amine based organic material, and if soluble in the organic solvent, C₅₋₂₀ aliphatic amine, heterocyclic amine, or amine having a benzene ring can be used.

Specifically, the amine based organic material can be at least one material selected from the group consisting of aniline, an N-alkylaniline, 2-ethylhexylamine, triethylamine, pentyl amine, n-hexylamine, p-aminobenzoic acid, pyrrolidine, pyrimidine, morpholine, pyridine, piperazine, and quinoline.

Furthermore, the polymer resin binder desirably has an appropriate molecular weight for inclusion in the inkjet ink for a color filter. The weight averaged molecular weight (Mw) thereof may be 1,000 to 100,000 g/mol, specifically 5,000 to 50,000 g/mol, and more specifically 10,000 to 20,000 g/mol. Generally the molecular weight of a polymer can be from more than hundreds of thousands to millions, but it is advantageous that the molecular weight of a polymer resin binder which is to have a low viscosity be small. That is, a polymer resin binder having a low molecular weight can be used in circumstances in which low viscosity is useful, such as a photosensitive resin for a color filter or an inkjet ink for a color filter.

The molecular weight of the polymer resin binder during synthesis is adjusted by reaction conditions, that is, the concentration of the functional monomer, the reaction temperature, and the amount of the initiator. For example, when the concentration of the functional monomer and the reaction temperature are high and the amount of the initiator used is large, the molecular weight is reduced.

Thus, a method of manufacturing the polymer resin binder of inkjet ink for a color filter comprises polymerizing multiple types of functional monomers and an amine based organic material. When the polymer resin binder is synthesized, the total amount of the functional monomer is 5-60 weight %, specifically 10-40 weight %, and more specifically 15-30 weight % based on 100 weight % of the total reaction material (i.e., monomer, solvent, and initiatior). The reaction temperature for the synthesis of the polymer resin binder may be 50-120° C., specifically 60-100° C., more specifically 70-90° C.

Free radical polymerization initiators may be used to polymerize the monomers, such as, for example, peroxy initiators, diazo initiators, and the like. An exemplary reaction initiator is 2,2′-azobisisobutyronitrile (“AIBN”). The reaction initiator can be used in an amount of 0.1-10 weight %, specifically 0.5-5 weight %, and more specifically 2-4 weight %, based on 100 weight % of the total functional monomer.

The polymer resin binder comprises a random type polymer and has an excellent dispersion effect characteristic. The synthesized polymer resin binder, either having the solvent removed or including the solvent, can be mixed with an appropriate amount of pigment and pulverized using various kinds of pulverizers. Generally, the polymer resin binder used can be present in an amount of 20 to 150 weight % based on 100 weight % of the total pigment, though the amount may vary depending on the type of pigment used. Also, the polymer resin binder can be applied directly to the next process without separating the solvent from the polymer resin binder when synthesized in an aprotic solvent.

Hereinafter, synthesis methods for forming the polymer resin binder according to the purpose of usage will be described in detail.

In a first exemplary embodiment, the synthesis of a polymer resin binder having a basic structure which can be included in inkjet ink for a color filter will be described.

First, benzyl methacrylate, methyl methacrylate, and methacrylic acid are mixed properly with PGMEA in a ratio of 0.7, 0.5, and 1.5 based on the molar ratio. Next, the temperature of the mixture is increased to about 100° C. and _ wt % of an initiator (AIBN) based on the total amount of monomer is added and reacted for 5 hours, while maintaining the above temperature. Next, 2 weight % of aniline based on 100 weight % of the total functional monomer is added to the reaction solution and left for 1 hour. Finally, when the reaction is completed, the used solvent is removed by vacuum distillation and a yellow colored solid is obtained. The synthesized polymer resin binder has a chemical structure represented by Formula 2.

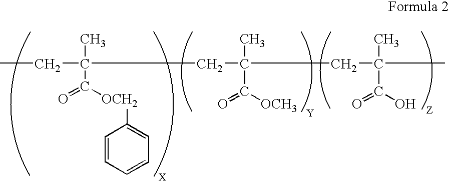

In Formula 2, X has a molar ratio from 0.3 to 3.0, Y has a molar ratio from 0.2 to 2.5, and Z has a molar ratio from 0.3 to 3.0. However, as desired, at least two kinds of each functional monomer can be used. This will be described later in more detail. Also, when PGMEA is used as a polymerization solvent, the solvent need not be removed by vacuum distillation as PGMEA can be used in a subsequent process for producing a pigment dispersion. Thus the synthesized polymer resin binder solution can be directly applied to the next process, thereby reducing the number of processes.

In a second exemplary embodiment of synthesis example, synthesis of a polymer resin binder having an intensified polarity structure will be described.

The solid structure and polarity of the polymer resin binder can be adjusted according to the physical and chemical properties of the pigment which is applied as described above, depending on the kinds and/or the molecular weights of the functional monomers used. For example, when 2-hydroxy methacrylate is used instead of methyl methacrylate which has a lower molecular weight, the solid structure and property of the binder becomes polar. Thus when the polymer resin binder is used in combination with a pigment having a strong polarity, the dispersion property and the dispersion stability of the polymer resin binder are likely to increase. The synthesized polymer resin binder has a chemical structure represented by Formula 3.

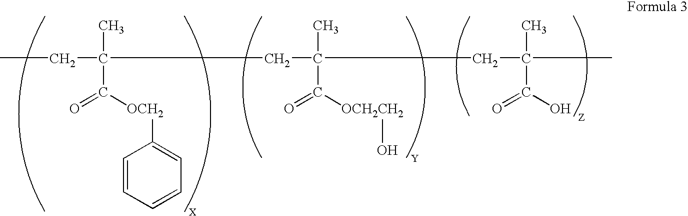

In Formula 3, the molar ratio of X is 0.3 to 3.0, the molar ratio of Y is 0.2 to 2.5, and the molar ratio of Z is 0.3 to 3.0. However, as desired, two or more kinds of each functional monomer can be used. This will be described in more detail later. The reaction solvent which is used in synthesis may be PGMEA or other aprotic organic solvent.

When a polymer resin binder having a chemical structure represented by Formula 3 is synthesized, 2.5 weight % of N-ethylaniline based on 100 weight % of the total functional monomer is added to complete the reaction. When the reaction is completed, the used solvent is removed by vacuum distillation and a yellow colored solid is obtained.

In a third exemplary embodiment, synthesis of a polymer resin binder having a weakened polarity structure will be described.

Monomers styrene, butyl methacrylate, and methacrylate acid are mixed with diglyme in a ratio of 1.5, 0.5, and 0.3, respectively, based on the molar ratio. Next, the temperature of the mixture was increased to about 80° C. and then an initiator (AIBN) was added and reacted for 4 hours while maintaining the above temperature. Next, 1.5 weight % of 2-ethylhexyl amine based on 100 weight % of the total functional monomer was added to the reaction solution to complete the reaction. The synthesized polymer resin binder has a chemical structure represented by Formula 4 below. In this case, the polymer resin binder has a reduced polarity, and when mixed with a pigment having a relatively small polarity, the polymer resin binder can have a good property.

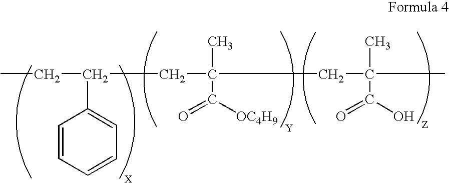

In Formula 4, the molar ratio of X is from 0.3 to 3.0, the molar ratio of Y is 0.2 to 2.5, and the molar ratio of Z is 0.3 to 3.0. However, where desired, two or more kinds of each functional monomer can be used. More will be described about this later. When the synthesized polymer resin binder is used in an organic solvent, the amount of the methacrylic acid is half the amount used in an aqueous solution to obtain a useful polymer.

In a fourth exemplary embodiment, synthesis of a polymer resin binder having a structure formed of a monomer only having an affinity for pigment and a monomer having an affinity for solvent will be described.

Monomers styrene and acrylic acid are mixed in a molar ratio and added to a solvent. Next, the temperature of the mixture is increased to 100° C. and an initiator (AIBN) is added and the mixture is reacted for 5 hours, while maintaining the temperature. Next, 2.4 weight % of morpholine based on 100 weight % of the total monomer is added to the reaction solution to complete the reaction. When the reaction is completed, the used solvent is removed by vacuum distillation, thereby obtaining a white solid. The synthesized polymer resin binder has a chemical structure represented by Formula 5 below.

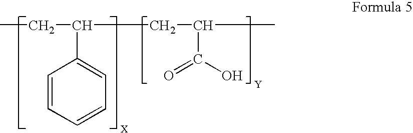

In Formula 5, the molar ratio of X is from 0.3 to 5, and the molar ratio of Y is from 0.3 to 5, and more specifically X is from 2 to 3 and Y is from 1.5 to 2. The synthesized polymer resin binder has a chemical structure represented by FIG. 5.

Hereinafter, a pigment dispersion containing the above described polymer resin binder will be described in detail.

The pigment dispersion of inkjet ink for a color filter according to the present embodiment comprises a pigment, dispersion agent, and surfactant in each polymer resin binder or in a binder mixture of two or three kinds of the polymer resin binders.

The pigment dispersion can also comprise multiple types of polymer resin binder. When multiple types of polymer resin binder are mixed to manufacture a pigment dispersion, the amount of each type of the binder may be 5-95 weight % based on the total amount of binder. In an embodiment, the total amount of the polymer resin binder used is 20-150 weight % based on 100 weight % of the total used pigment.

The pigment is pulverized to fine particles and supplied in the form of powder and air trapped on the surface of the pigment particle is discharged by mixing the pigment with the dispersion agent and agitating the mixture. Thus, when the air is released from the surface of the pigment particle, the solvent can readily permeate the surface of the pigment particle, which is known as a wetness effect and this is the characteristic of the dispersion agent. In an embodiment, the pigment may be at least one selected from the group of pigments consisting of red 254, red 177, blue 15:6, yellow 150, yellow 139, yellow 138, and violet 23, but is not limited to this.

The dispersion agent may be EFKA 4046 and/or 4047 available from Efka, a division of Ciba Specialty Chemicals; Solsperse® 32500 and/or Solsperse® 24000 available from Noveon; DisperBYK® 161 and/or DisperBYK® 163, available from BYK-Chemie; and the like, which are commercially available. The amount of the dispersion agent used may be 0.1-30 weight %, specifically 1-10 weight %, based on 100 weight % of the total pigment.

The surfactant may be a fluoric material. In an exemplary embodiment, the fluoric surfactant may be 3M™ Novec™ FC-4434 or FC-4430 available from 3M Corporation. When a fluoric surfactant is added, the dispersion property is improved and the dispersion stability is improved. The optimum amount of fluoric surfactant used can be decided in consideration of the kind of the polymer resin used, and can be 0.01-2 weight %, more specifically 0.1-0.5 weight %, based on 100 weight % of the total pigment.

It is desirable that the pigment is dispersed when used. For pigments used in various components of electronic devices, highly functional, low viscosity pigment dispersions are both useful and desirable. The pigments used in electronic components should be useful in forming a thin film, and therefore when using an application method to form the thin film such as, for example, a nozzle coating method or roll coating method, ejection properties of the pigment must be sufficient to provide uniform thin film coating properties. Accordingly, a high viscosity pigment dispersion cannot form a thin film readily, and the ejection property thereof is not adequate. Thus a high viscosity pigment dispersion is not appropriate for electronic devices.

Color filter photoresists (photosensitive medium) used in the manufacture of a color filter for a liquid crystal display device therefore desirably comprise a low viscosity pigment dispersion.

The pigment dispersion must have good heat resistance to high temperature, chemical resistance, and mechanical property which maintains a mechanical strength above a set value after hardening. For example, it is required a high functional pigment dispersion which can maintain stability of a disperse system in a high temperature process where the pigment dispersion is hardened at 220° C. for more than 1 hour during the manufacture of a color filter.

Also, with increased numbers of properties needed for a liquid crystal display device, the properties of the pigment dispersion for a color filter must also correspondingly increase to provide the properties. That is, the conventional pigment dispersion is generally used in the manufacture of a pigment dispersion for a spin coating with limits, but as liquid crystal display devices become larger than conventional liquid crystal display devices, other coating methods such as, for example, a blade, roll, nozzle coating method can be used instead of or in addition to spin coating methods. The pigment dispersions have properties which are appropriate for each coating method as needed.

Additional chemical materials are added to the pigment dispersion to be manufactured as inkjet ink for a color filter or a photosensitive agent, and accordingly, the pigment dispersion is required to have chemical resistance. The typical chemical materials added to the pigment dispersion are photosensitive agent, polymer resin binder, surfactant, monomer, viscosity controller, and the like.

When the pigment dispersion is bonded with the additives physically and/or chemically, the disperse system is destroyed, and the pigment in binder is hardened and layer separation occurs. Thus the value of the pigment dispersion as a product decreases and can lead to defects in the final product, a liquid crystal display device, creating a considerable amount of product loss and low product yield.

Thus, the pigment dispersion must have good chemical resistance and high mechanical strength. However, the properties of the conventionally commercialized products are limited and is thus difficult to disperse various kinds of pigments.

In the pigment dispersion according to the present embodiment, the pigment can be dispersed at about 15 weight % based on 100 weight % of the total pigment dispersion, and the viscosity thereof is low as about 20 cP (centipoise) and can be directly applied to a photosensitive resin for a color filter or an inkjet ink for a color filter.

For the pigment dispersion to have the above described properties, the polymer resin binder which is used in the manufacture of the pigment dispersion as described above is prepared so that it can provide one or more of the desired properties when used with the pigment dispersion. In an exemplary embodiment, the pigment dispersion according to the present embodiment is manufactured by the following process.

First, the polymer resin binder is mixed with a pigment and solvent present in predetermined amounts according to the limitations disclosed hereinabove. Next, the mixture undergoes a wetness process and is pulverized using a bead mill or a micro fluidizer. The result is a low viscosity pigment dispersion. Also, in order to increase the dispersion efficiency, two or three polymer resin binders can be mixed and used.

Meanwhile, various additives are added to the above described pigment dispersion agent to manufacture an inkjet ink for a color filter. The inkjet ink for a color filter can be manufactured by adding a polymer resin binder to the pigment dispersion.

In a specific embodiment, an inkjet ink for a color filter comprises a pigment dispersion, a solvent, polymer resin binder, surfactant, initiator, and other additives.

The solvent used in the manufacture of an inkjet ink affects the ejection property and ejection stability of the inkjet ink. The solvent used have a boiling point of greater than or equal to 150° C., however when the boiling point is greater than 300° C., some solvent remains behind during hardening and can be a factor causing pixel deterioration. In an embodiment, the boiling point of the solvent is 200-270° C.

The solvent, the surfactant, the initiator, and other additives useful for the inkjet ink are as described hereinabove, and the description thereof will not be repeated.

In an embodiment, a method of making an inkjet ink comprises mixing the pigment, the dispersion agent, the surfactant, and a polymer resin binder comprising an amine based organic material. In a specific embodiment, the polymer resin binder is added to the pigment dispersion. In an exemplary method, the inkjet ink is manufactured by adding a pigment dispersion to a reactor with an agitator and adding solvent, polymer resin binder, surfactant, initiator, and other additives, and agitating the mixture.

The present invention will be described in greater detail with reference to following examples. The following examples are for illustrative purposes and are not intended to limit the scope of the invention.

### EXAMPLES

Manufacture of Polymer Resin Binder

### Example 1

Benzyl methacrylate (0.07 mol, 12.3 g), methyl methacrylate (0.07 mol, 7.0 g), and methacrylic acid (0.075 mol, 6.5 g) were mixed in 100 g of PGMEA and a small amount of nitrogen was bubbled through to deoxygenate the mixture. The temperature of the mixture was increased to 80° C. and 0.28 g of an initiator (AIBN) was added and reacted at 80° C. for 5 hours. During reaction, nitrogen bubbling was continued to prevent contact with oxygen so that the generated radical did not quench. Thereafter, 0.52 g of aniline was added to the reaction solution. 1 hour after adding aniline, the temperature was slowly reduced to an ambient temperature. Thus a polymer resin binder solution containing about 20% solid content was obtained.

### Example 2

A polymer resin binder containing about 20% solid content was obtained in the same manner as in Example 1 except that styrene (0.07 mol, 7.3 g) instead of benzyl methacrylate and 1.1 g of pyrrolidine instead of aniline were added to 80 g of PGMEA.

### Example 3

A polymer resin binder containing about 20% solid content was obtained in the same manner as in Example 1 except that 2-hydroxy ethyl methacrylate (0.07 mol, 9.1 g) instead of methyl methacrylate, and 0.7 g of N-ethyl aniline instead of aniline were added to PGMEA.

### Example 4

Benzyl methacrylate (0.04 mol, 7.0 g), styrene (0.03 mol, 3.1 g), methyl methacrylate (0.07 mol, 7.0 g), and methacrylic acid (0.15 mol, 12.9 g) were mixed in 68 g of PGMEA and a small amount of nitrogen was bubbled through to deoxygenate the mixture. Then the temperature of the mixture solution was increased to 90° C. and 0.28 g of an initiator (AIBN) was added and the mixture was reacted for 5 hours at a temperature of 90° C. During reaction, nitrogen bubbling was continued to prevent contact with oxygen in the air so that the generated radical did not quench. Then 0.85 g of aniline was added to the reaction solution. 1 hour after adding aniline, the temperature was slowly reduced to an ambient temperature. Thus a polymer resin binder solution containing about 20% solid content was obtained.

### Example 5

Benzyl methacrylate (0.04 mol, 7.0 g), styrene (0.03 mol, 3.1 g), methyl methacrylate (0.05 mol, 5.0 g), and methacrylic acid (0.03 mol, 2.6 g) were mixed in 60 g of PGMEA and a small amount of nitrogen was bubbled through to deoxygenate the mixture. The temperature of the mixture was increased to 80° C. and 0.35 g of an initiator (AIBN) was added and reacted for 5 hours while maintaining a temperature of 100° C. During reaction, nitrogen bubbling was continued to prevent contact with oxygen in the air so that the generated radical did not quench. Then 1.0 g of morpholine was added to the reaction solution. 1 hour after adding the morpholine, the temperature was slowly reduced to an ambient temperature.

### Example 6

A polymer resin binder was obtained in the same manner as in Example 5 except that benzyl methacrylate was not added but styrene (0.07 mol, 7.3 g) was added and 0.8 g of triethylamine was added instead of morpholine.

### Example 7

Styrene (0.1 mol, 10.4 g) and acrylic acid (0.1 mol, 7.3 g) were mixed in 60 g of PGMEA and a small amount of nitrogen was bubbled through to deoxygenate the mixture. The temperature of the mixture was increased to 80° C. and 0.25 g of an initiator (AIBN) was added and reacted for 5 hours at 80° C. During reaction, nitrogen bubbling was continued to prevent contact with oxygen in the air so that the generated radical did not quench. Then 0.75 g of aniline was added to the reaction solution. 1 hour after adding aniline, the temperature was slowly reduced to an ambient temperature.

Manufacture of Pigment Dispersion

### Example 8

15 g of pigment red 254 (available from Ciba Specialty Chemicals, Switzerland) and 1.0 g of Solsperse® 32500, 0.2 g of Novec™ FC-4434, 78.8 g of PGMEA were mixed with 3.0 g of the polymer resin binder solution synthesized in Example 1 and 2.0 g of the polymer resin binder solution synthesized in Example 3 and this solution was agitated properly for 2 hours and wetted. Then 300 g of sand was added and pulverized for 5 hours at 3,000 rpm using a disk having a diameter of 7 cm. After pulverization was completed, the sand was removed using a sieve. Thus a red pigment dispersion having an average particle size of 75 nm was obtained.

### Example 9

10 g of red pigment 254 was mixed properly with 50 g of the polymer resin binder solution synthesized in Example 5 and agitated for 1 hour. Here, 100 g of zirconia beads of 0.3 mm were added and the mixture was pulverized for 3 hours at 3,000 rpm using a disk having a diameter of 7 cm. After pulverization was completed, the beads were removed using a sieve. Thus a red pigment dispersion having an average particle size of 80 nm was obtained.

### Comparative Example 1

A pigment dispersion was obtained using a commercial dispersion agent EFKA 4046, as disclosed in U.S. Pat. No. 6,696,207.

6 g of EFKA-466 and 15 g of red pigment 254, 79 g of PGMEA were mixed and this mixture was agitated properly for 2 hours and wetted. Here, 300 g of sand was added and the mixture was pulverized for 5 hours using a disk having a diameter of 7 cm at 3,000 rpm. After pulverization was completed, a sieve was used to remove the sand. Thus a red pigment dispersion having an average particle size of 78, nm was obtained.

Manufacture of Inkjet Ink

### Example 10

20 g of polymer resin binder synthesized in Example 1, 5 g of dipentaerythritol pentaacrylate, which is a functional monomer, and 0.2 g of AIBN, which is a thermal initiator, were mixed with 44.8 g of diethyleneglycol monobutyl ether acetate, an organic solvent. Here, 30 g of pigment dispersion manufactured in Example 7 was slowly added and agitated. Then, the mixed solution was passed through a 10-micrometer filter to remove coarse particles so the filtered solution could be used to manufacture inkjet ink for a color filter.

Test of Average Particle Size and Stability Test of the Manufactured Pigment Dispersion According to Time

The pigment dispersion is tested for dispersion stability to ensure the particles do not stick to each other and precipitate, and so layers of the pigment dispersion do not separate. The pigment dispersion is observed over time, and as time passes, the size and viscosity of the particle should show little change. Change in the size and viscosity of the particle is undesirable and denotes that the disperse system is unstable and thus unusable, meaning that the pigment dispersion cannot perform a basic function as a pigment dispersion.

The dispersion stability test is to observe the time passage stability using a particle size analyzer (“PSA”), and in order to observe within a short time, an accelerated test was performed. The accelerated stability test was performed at 60° C. for 4 hours and at −10° C. for 4 hours, and this was repeated 4 times to observe the change in particle size.

The results of the accelerated stability test are listed in Table 1 below. Here, the pigment dispersions of Example 8 and Comparative Example 1 were used.

TABLE 1

| | Example 8 | | Comparative Example 1 | |
|---|---|---|---|---|
| Content of | Binder of | 3.0 wt % | EFKA 4046 | 6.0 wt % |
| components | Example 1 | | | |
| in the | Binder of | 2.0 wt % | Red | 15.0 wt % |
| pigment | Example 3 | | pigment 254 | |
| dispersion | Solsperse ® | 1.0 wt % | Solvent | 79.0 wt % |
| | 32500 | | (PGMEA) | |
| | Red pigment 254 | 15.0 wt % | | |
| | Novec ™ | 0.2 wt % | | |
| | FC-4434 | | | |
| | Solvent | 78.8 wt % | | |
| | (PGMEA) | | | |

| | | |
|---|---|---|
| Average | 75 nm | 78 nm |
| particle size | | |
| before | | |
| stability test | | |
| Average | 79 nm | 82 nm |
| particle size | | |
| after stability | | |
| test | | |

The average particle size and stability according to time of the pigment dispersion will be examined with reference to Table 1.

In the case of the pigment dispersion of Example 8, the average particle size was 75 nm and 79 nm before and after the stability test, respectively. On the other hand, in the case of Comparative Example 1, which is a conventional pigment dispersion, the average particle size was 78 nm and 82 nm before and after the stability test, respectively. Accordingly, the average particle size of the pigment dispersion in the present invention was smaller by about 3 nm than that in the conventional art both before and after the stability test. Accordingly, the dispersion property of the pigment dispersion according to an embodiment of the present invention is better than the conventional pigment dispersion.

Also, the average particle size before and after stability test according to time both increase by about 4 nm. Thus Table 1 shows that the pigment dispersion according to the present embodiment has a good dispersion property and the same degree of dispersion stability as that of the conventional art. Accordingly, as evident from the results of the test, there is no difficulty in using the pigment dispersion according to the present invention commercially and the dispersion property thereof is better compared to the conventional art.

Test of Election Property and Ejection Stability of the Manufactured Inkjet Ink

An ejection test was performed using a Litrex inkjet system in which a spectra inkjet head was mounted. Stable ejection without clogging of a head during ejection for a predetermined period of time without measurable change in the amount of ejected ink was considered as the test standard.

The test result is listed in Table 2. The inkjet ink manufactured in Example 10 was used. However, the present invention is not limited to this but can be manufactured by combination of the above described pigment dispersion, a polymer resin binder, a hardening monomer, a heat initiator, a solvent, and the like.

TABLE 2

| Example 10 | | Ejection stability |
|---|---|---|
| Pigment dispersion manufactured in Example 7 | 30 wt % | During ejection for 3 |
| Polymer resin binder manufactured in Example 1 | 20 wt % | continuous hours, ink was |
| Hardening monomer (Dipentaerythritol | 5 wt % | stably ejected without any |
| pentaacrylate) | | change as the droplet of the |
| Thermal initiator (AIBN) | 0.2 wt % | initial ejection ink and the final |
| Organic solvent (Diethyleneglycol monobutyl ether | 44.8 wt % | ejection ink both had a |
| acetate) | | diameter of 100 μm. |

As evident from Table 2, the inkjet ink according to the present embodiment has a very good ejection property and ejection stability.

Test of Degree of Condensation of Inkjet Ink Coated on a Color Filter of a Liquid Crystal Display Device

The effect of adding an amine based organic material was observed experimentally.

FIG. 2A is a photograph showing the degree of condensation of an inkjet ink not containing amine based organic material used to form a conventional color filter. FIG. 2B is a photograph showing the degree of condensation of an inkjet ink containing an amine based organic material for a color filter according to an embodiment of the present invention.

In FIGS. 2A and 2B, (R), (G), and (B) denote red, green, and blue sub-pixels of a color filter, respectively.

Referring to FIGS. 2A and 2B, when an amine based organic material was not added, the condensation of the particles was prominent, and when an amine based organic material was added, the condensation of the particles was remarkably reduced.

Hereinafter, the effect of the amine based organic material to the condensation of ink particles will be described in detail with respect to the attached drawings.

First, an inkjet ink is coated inside each sub-pixel of a liquid crystal display device. Then, a solvent included in the inkjet ink is dried and the amount of solid content of the inkjet ink increases. Here, when an amine based organic material is not added, the dispersion balance of the dispersion agent, the polymer resin binder, and the pigment shows defects, and as illustrated in FIG. 2A, condensation of the ink particles occurs and the inkjet ink becomes opaque.

However, when an amine based organic material is added, the amine based organic material physically bonds with acid and amine which are present in the dispersion agent or in the polymer resin binder and thus improves the dispersion stability. Accordingly, as illustrated in FIG. 2B, the inkjet ink having the amine based organic material added prevents the condensation of ink particles.

According to an embodiment of the present invention, a polymer resin binder which can improve the dispersion property and dispersion stability of the pigment when added during the manufacture of an inkjet ink for a color filter of a liquid crystal display device is provided.

Also, according to an embodiment of the present invention, a polymer resin binder which is used to manufacture an inkjet ink for a color filter of a liquid crystal display device to improve the ink ejection property and ejection stability from an inkjet head is provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A polymer resin binder of inkjet ink for a color filter comprising a polymer of multiple types of functional monomer, wherein the polymer resin binder contains an amine based organic material represented by Formula 1:
[—NHₓR_{y}], Formula 1
where R is a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkyl aryl group, a C₇₋₄₀ arylalkyl group, a C₈₋₄₀ arylalkenyl group, or a C₂₋₁₀ alkynyl group; and x is 0 to 2, y is 1 to 3, and x+y=3.

2. The polymer resin binder of claim 1, wherein the functional monomer comprises:
(a) styrene or benzyl methacrylate; and
(b) methacrylic acid, acrylic acid, methacrylamide, or acrylamide.

3. The polymer resin binder of claim 1, wherein the amine based organic material is at least one selected from the group consisting of aniline, N-alkylaniline, 2-ethylhexylamine, triethylamine, pentyl amine, n-hexylamine, p-aminobenzoic acid, pyrrolidine, pyrimidine, morpholine, pyridine, piperazine, and quinoline.

4. The polymer resin binder of claim 1, wherein the amine based organic material is 0.1-30 weight % based on 100 weight % of the total of (a) and (b).

5. The polymer resin binder of claim 1, wherein when the molar content of (a) is 0.3 to 5, the molar content of (b) is 0.3 to 5, based on the molar ratio of (a) and (b).

6. The polymer resin binder of claim 1, wherein the functional monomer further comprises (c) methacrylate having a C₁₋₅ alkyl group or 2-hydroxy ethyl group.

7. The polymer resin binder of claim 6, wherein the content of the amine based organic material is 0.1 to 30 weight % based on 100 weight % of the total of (a), (b), and (c).

8. The polymer resin binder of claim 6, wherein when the molar content of (a) is 0.3 to 3.0, the molar content of (b) is 0.2 to 2.5, and the molar content of (c) is 0.3 to 3.0, based on the molar ratio of (a), (b), and (c).

9. The polymer resin binder of claim 1, wherein the amine based organic material is in a physically bonded state.

10. The polymer resin binder of claim 1, wherein the amine based organic material is in a chemically bonded state.

11. A pigment dispersion included in an inkjet ink for a color filter comprising a pigment, a dispersion agent, a surfactant, and the polymer resin binder of claim 1.

12. The pigment dispersion of claim 11, wherein the surfactant is a fluoric surfactant.

13. The pigment dispersion of claim 11, wherein the pigment is at least one selected from the group of pigments consisting of red 254, red 177, blue 15:6, green 36, yellow 150, yellow 139, yellow 138, and violet 23.

14. The pigment dispersion of claim 11, wherein the content of the polymer resin binder is 20-150 weight % based on 100 weight % of the total pigment.

15. The pigment dispersion of claim 11, wherein the content of the dispersion agent is 0.1-30 weight % based on 100 weight % of the total pigment, and the content of the surfactant is 0.01-2 weight % based on 100 weight % of the total pigment.

16. An inkjet ink for a color filter comprising the pigment dispersion of claim 11.

17. A pigment dispersion included in an inkjet ink for a color filter comprising at least two polymer resin binders of claim 1, and further comprising a pigment, a dispersion agent, and surfactant with the binder mixture.

18. The pigment dispersion of claim 17, wherein the surfactant is a fluoric surfactant.

19. The pigment dispersion of claim 17, wherein the pigment is at least one selected from the group of pigments consisting of red 254, red 177, blue 15:6, green 36, yellow 150, yellow 139, yellow 138, and violet 23.

20. The pigment dispersion of claim 17, wherein the content of the binder mixture is 20-150 weight % based on 100 weight % of the total pigment.

21. The pigment dispersion of claim 17, wherein the content of the dispersion agent is 0.1-30 weight % based on 100 weight % of the total pigment, and the content of the surfactant is 0.01-2 weight % based on 100 weight % of the total pigment.

22. An inkjet ink for a color filter comprising the pigment dispersion of claim 17.

23. A method of manufacturing a polymer resin binder of inkjet ink for a color filter comprising polymerizing multiple types of functional monomer, wherein the polymer resin binder comprises an amine based organic material represented by Formula 1:
[—NHₓR_{y}], Formula 1
where R is a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkyl aryl group, a C₇₋₄₀ arylalkyl group, a C₈₋₄₀ arylalkenyl group, or a C₂₋₁₀ alkynyl group; and x is 0 to 2, y is 1 to 3, and x+y=3.

24. A method of manufacturing a pigment dispersion included in an inkjet ink for a color filter comprising mixing a pigment, a dispersion agent, a surfactant, and a polymer resin binder comprising:
an amine based organic material represented by Formula 1:
[—NHₓR_{y}], Formula 1
where R is a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkyl aryl group, a C₇₋₄₀ arylalkyl group, a C₈₋₄₀ arylalkenyl group, or a C₂₋₁₀ alkynyl group; and x is 0 to 2, y is 1 to 3, and x+y=3.

25. The method of claim 24, wherein the polymer resin binder is added to the pigment dispersion.

26. The method of claim 24 comprising mixing at least two polymer resin binders to form a binder mixture, and further mixing a pigment, a dispersion agent, and surfactant with the binder mixture.

27. A method of manufacturing an inkjet ink, comprising mixing a pigment, a dispersion agent, a surfactant, and a polymer resin binder comprising:
an amine based organic material represented by Formula 1:
[—NHₓR_{y}], Formula 1
where R is a C₁₋₂₀ alkyl group, a C₁₋₁₀ alkoxy group, a C₆₋₂₀ aryl group, a C₆₋₁₀ aryloxy group, a C₂₋₂₀ alkenyl group, a C₇₋₄₀ alkyl aryl group, a C₇₋₄₀ arylalkyl group, a C₈₋₄₀ arylalkenyl group, or a C₂₋₁₀ alkynyl group; and x is 0 to 2, y is 1 to 3, and x+y=3.

28. The method of claim 27, wherein during the manufacture of the inkjet ink the polymer resin binder is added to the pigment dispersion.
